(19) United States
(12) Patent Application Publication
(10) Pub. No.: US 2014/0078063 A1
(43) Pub. Date: Mar. 20, 2014

(54) GESTURE-INITIATED KEYBOARD FUNCTIONS

(71) Applicant: MICROSOFT CORPORATION, Redmond, WA (US)

(72) Inventors: Steven Nabil Bathiche, Kirkland, WA (US); William A. Buxton, Toronto (CA); Moshe R. Lutz, Bellevue, WA (US)

(73) Assignee: MICROSOFT CORPORATION, Redmond, WA (US)

(21) Appl. No.: 13/712,111

(22) Filed: Dec. 12, 2012

Related U.S. Application Data
(60) Provisional application No. 61/702,723, filed on Sep. 18, 2012.

(51) Int. Cl. G06F 3/01

(52) U.S. Cl. CPC G06F 3/017
USPC 345/168

(57) ABSTRACT

Gesture-initiated keyboard operations are described. In one or more implementations, one or more touch inputs that involve interaction with a key of a keyboard are identified. Touch inputs can be identified using touchscreen functionality of a display device or using one or more pressure-sensitive touch sensors. Based on this touch input(s), a gesture is recognized. The gesture is configured to initiate an operation that corresponds to at least one key that is not included in the keys of the keyboard. In one or more implementations, the operation is a shift, caps lock, backspace, enter, tab, or control operation.

### RELATED APPLICATIONS

This application claims priority under 35 U.S.C. §119(e) to U.S. Provisional Patent Application No. 61/702,723, filed Sep. 18, 2012, Attorney Docket Number 337229.01, and titled “Keyboard Experience for Mobile Devices,” the entire disclosure of this application being incorporated by reference in its entirety.

### BACKGROUND

Many keyboards employ a keyboard format having a standard spacing from the middle of one key to the middle of an adjacent key as well as a standard size for those keys. Consequently, users that have gained familiarity with these keyboard formats may have difficulty when interacting with keyboards with spacing that is different than that of a standard keyboard. For example, non-standard spacing and sizes may prevent a user from utilizing muscle memory to type. This can cause a user to have a poor and unproductive typing experience and lead to user frustration.

Maintaining the standard keyboard spacing, however, may yield a keyboard that has a minimum size that may hinder the mobility of a mobile computing device. For instance, a QWERTY keyboard with a standard key spacing and key size may be no smaller than approximately eleven inches and therefore a conventional mobile computing device that employs such a keyboard has a corresponding size. Accordingly, conventional techniques involved tradeoffs between a size of a keyboard and desired mobility of a device that employs the keyboard.

### SUMMARY

Gesture-initiated keyboard functions are described. In one or more implementations, one or more touch inputs are detected. Touch inputs can be detected using touch sensors associated with keys of a keyboard. Based on the touch inputs, a gesture indicative of a keyboard function is recognized. The indicated keyboard function is not available for input using the keys of the keyboard absent recognition of the gesture. The keyboard function, for instance, may be conventionally associated with a key of a keyboard format with which the keyboard substantially complies but is not included as part of the keyboard. In one or more implementations, the function is a shift, caps lock, backspace, enter, tab, control function, and so on.

In one or more implementations, a system includes a computing device and a pressure-sensitive keyboard. Keys of the pressure-sensitive keyboard detect touch inputs. The computing device identifies a gesture from the touch inputs and, based on the gesture, identifies a keyboard function.

In one or more implementations, responsive to recognition of a gesture, a radial menu is presented in a user interface. A touch input associated with the radial menu is received, and based on the touch input, a keyboard function is performed.

In one or more implementations, touch inputs are detected using touch sensors associated with keys of a keyboard. Based on the touch inputs, a gesture indicative of a mousing function is recognized. In one or more implementations, the mousing function is a function configured to click, scroll, pan, zoom, move a cursor or pointer displayed on a display device, cause a menu to be displayed on a user interface, or the like.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

The detailed description is described with reference to the accompanying figures. In the figures, the left-most digit(s) of a reference number identifies the figure in which the reference number first appears. The use of the same reference numbers in different instances in the description and the figures may indicate similar or identical items. Entities represented in the figures may be indicative of one or more entities and thus reference may be made interchangeably to single or plural forms of the entities in the discussion.

FIG. 1 is an illustration of an environment in an input device implementing the techniques described herein.

FIG. 2 is an illustration of the computing device of FIG. 1 displaying a virtual keyboard.

FIG. 3 illustrates an example input device with example gestures that can be recognized in accordance with the techniques described herein to indicate backspace and tab functions.

FIG. 4 illustrates an example input device with example gestures that can be recognized in accordance with the techniques described herein to indicate escape and enter functions.

FIG. 5 illustrates an example input device with example gestures that can be recognized in accordance with the techniques described herein to indicate delete and shift functions.

FIG. 6 illustrates an example input device with an example gesture that can be recognized in accordance with the techniques described herein to indicate a shift function.

FIG. 7 illustrates an example input device with an example gesture that can be recognized in accordance with the techniques described herein to indicate an alt function.

FIG. 8 illustrates an example input device including a navigation key in accordance with the techniques described herein.

FIG. 9 illustrates an example input device with an example gesture that can be recognized in accordance with the techniques described herein to indicate a caps lock function.

FIG. 10 illustrates an example input device with a toggle region in accordance with the techniques described herein.

FIG. 11 illustrates an example input device with an example gesture that can be recognized in accordance with the techniques described herein to indicate a mousing function.

FIG. 12 illustrates an example computing device displaying an example radial menu in accordance with the techniques described herein.

FIG. 13 is a flowchart illustrating an example procedure for generating an input that corresponds to an indicated keyboard function in accordance with one or more embodiments.

FIG. 14 is a flowchart illustrating an example procedure for recognizing a gesture from a touch input in accordance with one or more embodiments.

FIG. 15 is a flowchart illustrating an example procedure for generating an input that corresponds to an indicated mousing function in accordance with one or more embodiments.

FIG. 16 is a flowchart illustrating an example procedure for recognizing a gesture from a touch input in accordance with one or more embodiments.

FIG. 17 is a flowchart illustrating another example procedure for presenting a radial menu in accordance with one or more embodiments.

FIG. 18 illustrates an example system including various components of an example device that can be implemented as any type of computing device as described with reference to FIGS. 1-17 to implement embodiments of the techniques described herein.

### DETAILED DESCRIPTION

### Overview

Modified key spacing and key size conventionally associated with keyboards for use with mobile computing devices can render it difficult for users to utilize these devices for providing a large amount of input. For example, a user may find it difficult to type a long document or email using a keyboard of a conventional mobile computing device. This is because many mobile computing devices employ non-standard keyboard formats to achieve a smaller overall device. Thus, in order for a mobile computing device with an associated keyboard to have a size of less than eleven inches, conventional techniques have altered spacing and/or size of the keys of the keyboard.

Techniques described herein enable gesture-initiated keyboard functions. Gestures can be recognized from touch inputs received by touch sensors in a keyboard, such as a pressure sensitive keyboard, virtual keyboard, and so on. Through gesture-recognition, keyboard functions that are not available for input using the keys of the keyboard can be initiated. These techniques may be employed such that various keys conventionally included in a keyboard format that correspond to functions can be removed from the keyboard. For example, gestures can indicate the functions of editing and navigational keys such as the backspace, tab, caps lock, shift, control, enter, and escape keys of a QWERTY keyboard format. Because the functions normally associated with those keys are indicated by gestures, the keys that correspond to these functions may be eliminated from the keyboard without affecting the functionality of the keyboard. Thus, a fully functional QWERTY keyboard with standard key spacing and key size can be made smaller than the conventional size.

Techniques described herein also enable gestures indicative of mousing functions to be recognized when performed on the keys of the keyboard. For example, gestures can indicate the functions associated with of clicking, scrolling, panning, zooming, moving a cursor or pointer displayed on a display device, causing a menu to be displayed on a user interface, or the like. These techniques may be employed such that a mousing track pad or designated mousing area can be removed from a computing device. Thus, a computing device can receive inputs corresponding to mousing functions without having a dedicated mousing area. Further discussion of examples of gestures and keyboard and mousing functions may be found in relation to the following sections.

In the following discussion, an example environment is first described that may employ the techniques described herein. Example procedures are then described which may be performed in the example environment as well as other environments. Consequently, performance of the example procedures is not limited to the example environment and the example environment is not limited to performance of the example procedures.

Example Environment

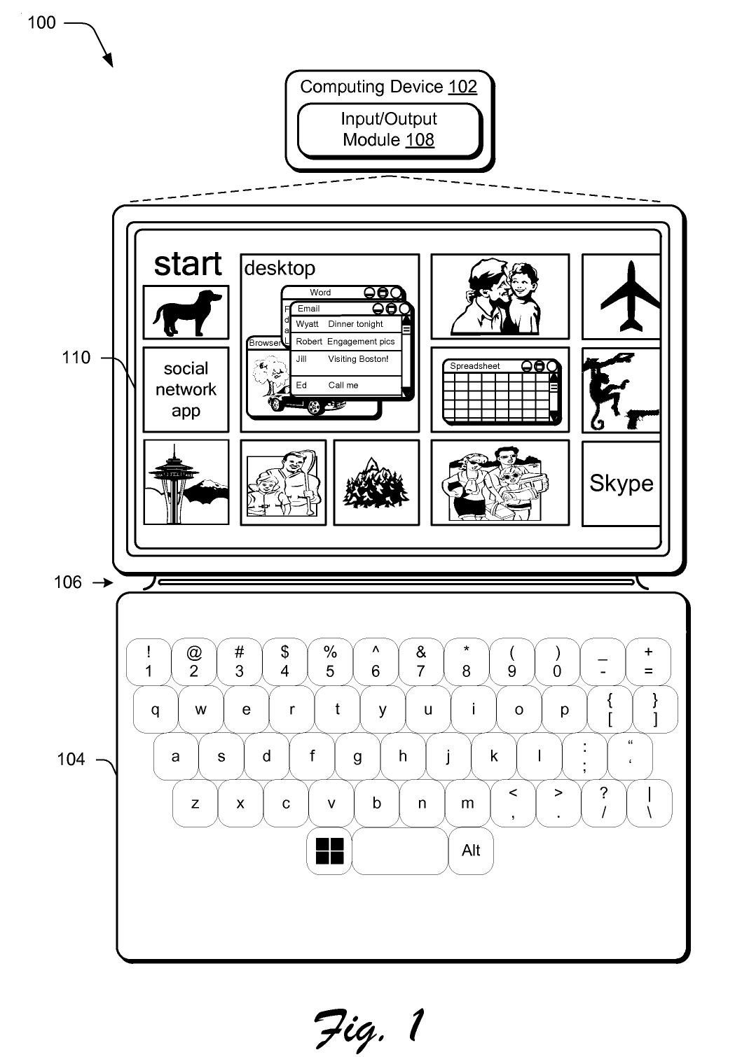

FIG. 1 is an illustration of an environment 100 in an example implementation that is operable to employ the techniques described herein. The illustrated environment 100 includes an example of a computing device 102 that is physically and communicatively coupled to a keyboard 104 via a flexible hinge 106. The computing device 102 may be configured in a variety of ways. For example, the computing device 102 may be configured for mobile use, such as a mobile phone, a tablet computer as illustrated, and so on. Thus, the computing device 102 may range from full resource devices with substantial memory and processor resources to a low-resource device with limited memory and/or processing resources. The computing device 102 may also relate to software that causes the computing device 102 to perform one or more operations.

The computing device 102, for instance, is illustrated as including an input/output module 108. The input/output module 108 is representative of functionality relating to processing of inputs and rendering outputs of the computing device 102. A variety of different inputs may be processed by the input/output module 108, such as inputs relating to functions that correspond to keys of the keyboard 104 or keys of a virtual keyboard displayed by the display device 110, inputs that correspond to gestures that may be recognized from touch inputs detected by the keyboard 104 and/or touchscreen functionality of the display device 110, and so forth. Thus, the input/output module 108 may support a variety of different input techniques by recognizing and leveraging a division between types of inputs including key presses, gestures, and so on.

In the illustrated example, the keyboard 104 is configured as having an arrangement of keys that substantially corresponds to a QWERTY arrangement of keys. As shown in FIG. 1, the keyboard 104 includes the alphanumeric keys of the QWERTY format. One or more keys that correspond to various keyboard functions are not included as part of the keyboard. The one or more keys that are not included can be one or more keys that are conventionally located at the edge of the keyboard format. For example, the keyboard 104 does not include a shift, control, caps lock, enter, or escape key in the illustrated example. However, other arrangements of keys are also contemplated. Thus, the keyboard 104 and keys incorporated by the keyboard 104 may assume a variety of different configurations to support a variety of different functionality.

During interaction with the keyboard 104, a user may provide various touch inputs to the keys of the keyboard 104. When the user provides an input to a key, a touch sensor associated with the key detects the touch and provides the information to the input/output module 108. The input/output module 108 can recognize the touch input as corresponding to a key press, such as when the user presses down on the “d” key. The input/output module 108 can also recognize a gesture indicative of a keyboard function or a mousing function from the touch input as further described below.

In conventional devices associated with a keyboard, the keyboard included a variety of keys that are selectable to input a variety of keyboard functions. For example, the keyboard may include alphanumeric keys to provide inputs of letters and numbers. The keyboard may also be configured to provide keyboard functions responsive to selection of multiple keys, such as a shift and a letter or number, control key, and so on. Thus, the keyboard may include a variety of different keys that are selectable alone or in combination to initiate a variety of corresponding keyboard functions.

By recognizing gestures indicative of keyboard functions, touch inputs to the keys of the keyboard 104 can be detected and used by input/output module 108 to generate an input that corresponds to a keyboard function that is not available for input using the keys of the keyboard 104. For example, touch sensors in the keys of the keyboard 104 can detect touches when a user swipes to the right on the keys, and enable the input/output module 108 to recognize the gesture as indicating a tab function. Thus, the input/output module 108 can generate an input that corresponds to the tab function though the keyboard 104 does not include a tab key. In this way, keys of the keyboard may be “removed” (i.e., not included) and therefore enable a smaller size yet still support conventional spacing and size of the keys, further discussion of which may be found in relation to the following figure.

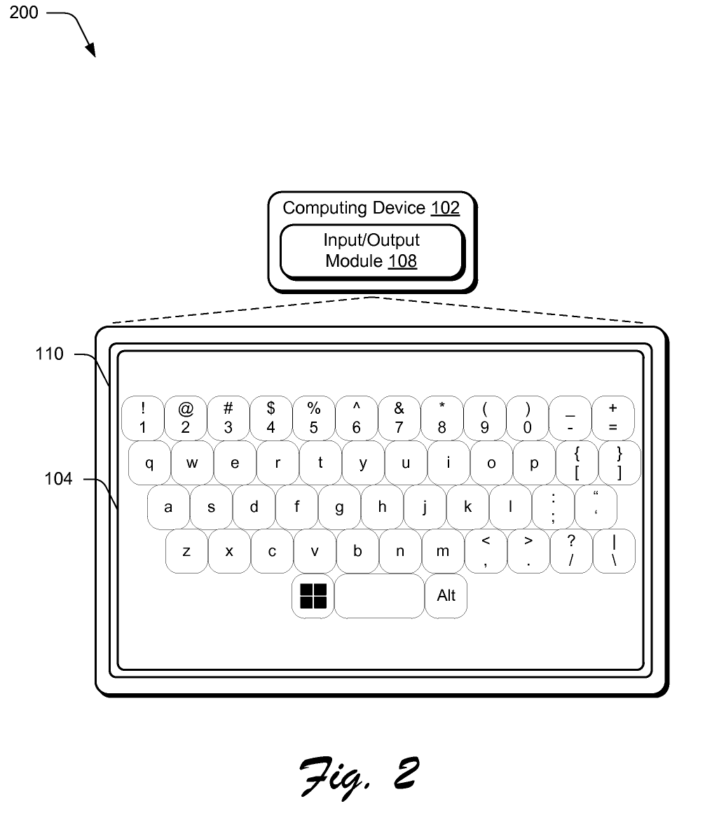

FIG. 2 illustrates an environment 200 in another example implementation that is operable to employ the techniques described herein. The illustrated environment 200 includes an example computing device 102 displaying a virtual keyboard 104. Virtual keyboard 104 is a multi-use device, supporting various types of user inputs analogous to the keyboard of keyboard 104 of FIG. 1. However, rather than being a physically separate device, the keyboard 104 is a virtual keyboard that is displayed by the display device 110 and thus may also serve as an input device for the computing device 102.

Like the keyboard 104 in FIG. 1, the keyboard 104 in FIG. 2 includes a display of the alphanumeric keys of the QWERTY format. One or more keys that correspond to various keyboard functions are not included as part of the keyboard 104. Rather, various keyboard functions can be indicated by gestures performed on the keyboard 104 and detected by touch sensors associated with the keyboard 104.

The touch sensors can take a variety of forms. For example, a touch sensor can be implemented as a digitizer or sensing element associated with the display device 110 that can sense proximity of an object to corresponding portions of the keyboard 104. Technologies such as capacitive field technologies, resistive technologies, optical technologies, and other input sensing technologies can also be utilized to detect the touch input. In other implementations, such as the one illustrated in FIG. 1, a touch sensor can be configured as a pressure-sensitive touch sensor. Thus, regardless of the specific technology employed, touch sensors associated with keys of the keyboard 104 can enable the computing device 102 to recognize a gesture indicative of a keyboard function or a mousing function.

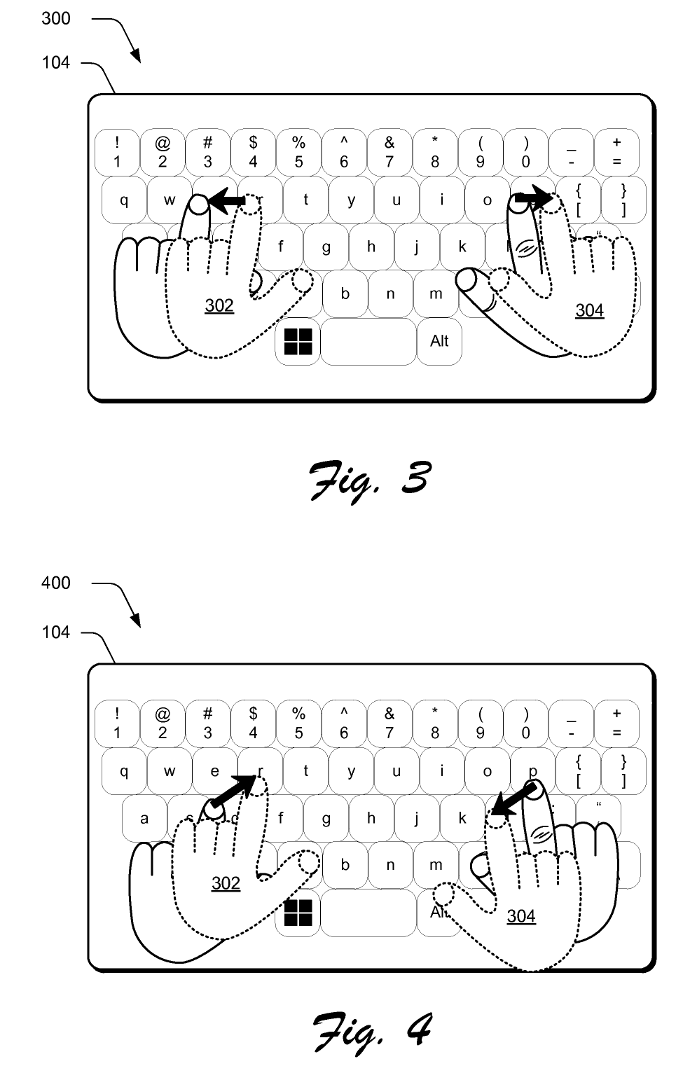

Various gestures can be indicative of keyboard functions. For example, gestures can be utilized to indicate navigation or editing functions, such as backspace, tab, delete, or escape functions. As another example, gestures may indicate other functions, such as modification functions. Such functions can include shift, caps lock, control, or alt functions. Gestures that are indicative of these keyboard functions may include gestures performed by one or more fingers on one or more keys of the keyboard. Consider, for example, FIG. 3.

FIG. 3 depicts an example implementation 300 of a user interacting with an example keyboard 104. A user's left hand 302 is shown performing a gesture in which a finger of the left hand 302 swipes from right to left across one or more keys. Such a gesture can indicate a backspace function, for example. In some implementations, the amount of movement on the screen can be correlated with the size, speed and/or pressure of the touch input. Thus, in this example, the velocity of the swipe may indicate a number of characters to be deleted to the left of a display cursor. Alternately or in addition, the number of characters to be deleted can be indicated by the distance the user swipes. For example, when the user swipes from the “r” key to the “e” key, a single character may be deleted. However, when the user swipes from the “y” key to the “q” key, an entire row of characters may be deleted.

Also shown in FIG. 3 is a user's right hand 304. The right hand 304 is shown performing a gesture in which a finger of the right hand 304 swipes from left to right across one or more keys. Such a gesture can indicate a tab function, for example.

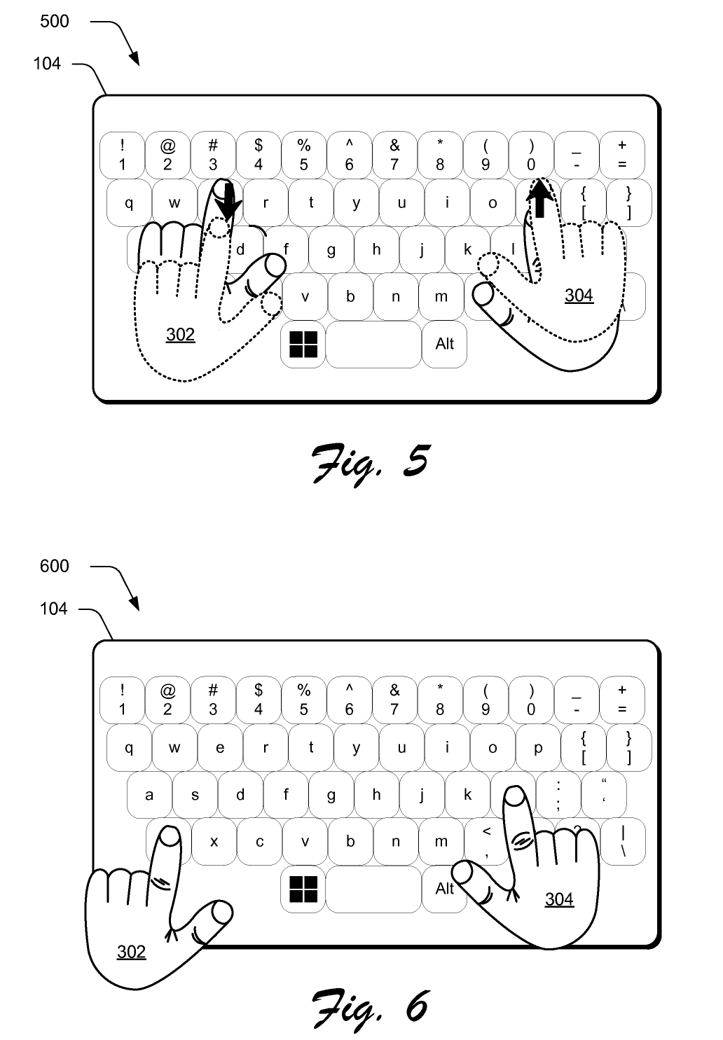

FIG. 4 illustrates another example implementation 400 of an example keyboard 104 receiving touch inputs from a user. Here, a user's left hand 302 is shown performing a gesture in which a finger of the left hand 302 swipes up and to the right across one or more keys. Such a gesture can indicate an escape function. The right hand 304 in FIG. 4 is shown performing a gesture in which a finger of the right hand 304 swipes down and to the left across one or more keys. Such a gesture can indicate an enter function.

Additional gestures are illustrated in implementation 500 in FIG. 5. In implementation 500, the user's left hand 302 swipes down on a key of the example keyboard 104. This gesture can indicate a delete function. Thus, responsive to recognizing the gesture performed by the left hand 302, one or more characters to the right of a cursor may be deleted. As with the gesture to indicate the backspace function, the distance of the swipe or the velocity of the swipe used to indicate the delete function may also indicate a number of characters to be deleted. Therefore, a downward swipe from the “e” key to the “x” key may function similar to when a user presses and holds down a “delete” key on a conventional keyboard. A downward swipe from the top of a key to the bottom of the same key may function similar to when a user taps the “delete” key.

In various implementations, gestures are recognized independent of the location on the keyboard at which they are performed. For example, FIGS. 3-5 illustrate the left hand 302 and the right hand 304 as performing gestures indicative of keyboard functions on the “r” and “p” keys, respectively. However, the gestures can be recognized when they are performed anywhere on the keyboard.

Other implementations are also contemplated in which the location at which the gesture is performed on the keyboard is a factor in the input that is generated. For instance, a gesture can be used to indicate a modification function and the location can identify the key to be modified. Consider the example that is illustrated by the user's right hand 304 in FIG. 5.

The user's right hand 304 in FIG. 5 is illustrated as swiping up on a key. Such a gesture can indicate a shift function. Thus, responsive to recognizing the gesture performed by the right hand 304 performed on the “p” key, a capital “P” may be inserted. However, if the gesture is performed on the “f” key, as an example, a capital “F” may be inserted. As another example, responsive to recognizing a swipe up on the “3” key, a “#” may be inserted. Thus, though the gesture of swiping up indicates the shift function, the key on which the gesture is performed can indicate the key that is to be modified by the shift function.

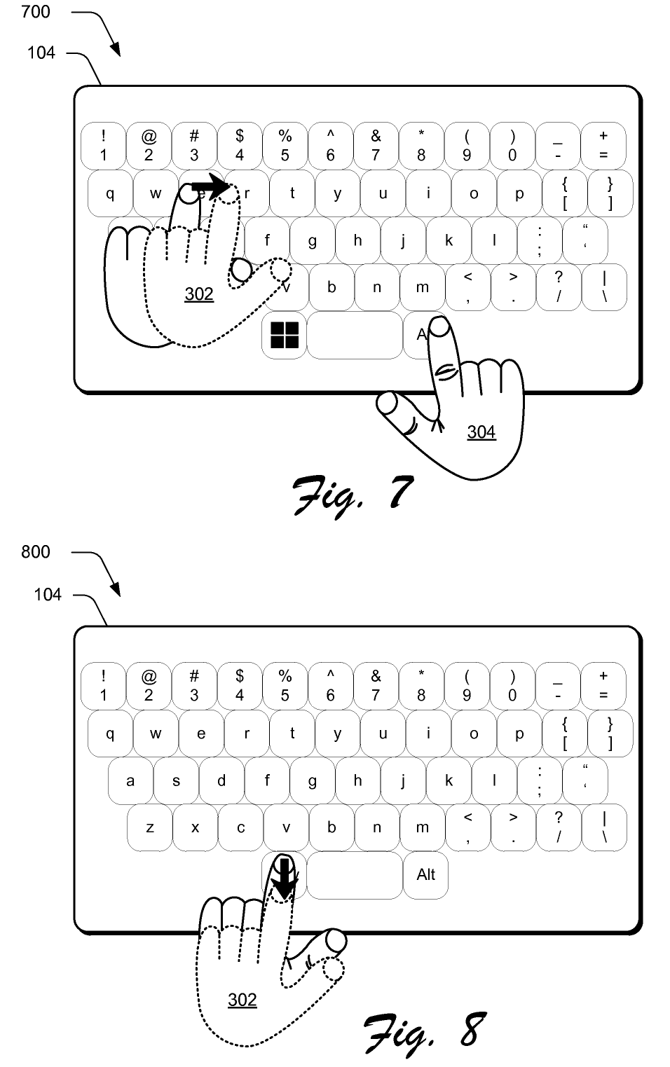

In various implementations, the keyboard function indicated by a gesture is conventionally associated with a key selectable in combination with another key. Accordingly, a gesture may be recognized from multiple touch inputs. FIG. 6 illustrates but one example of such a gesture. In the implementation 600 shown in FIG. 6, the user's left hand 302 is illustrated as pressing the “z” key while the user's right hand 304 is illustrated as pressing the “1” key of the keyboard 104. This two-key press is a gesture that can be recognized as indicating a shift function. Accordingly, when the “z” key is pressed singly, no gesture is recognized as indicating a keyboard function, and a key press is instead recognized. However, when the “z” key is selected in combination with another key, a gesture is recognized from the multiple touch inputs and an input corresponding to the shift function is generated.

In some implementations, the “I” key can function in a similar manner. For example, when a user presses the “I” key, a key press is identified and the “I” character can be input. However, when a user presses the “I” key in combination with another key, a gesture corresponding to the shift function can be recognized. The dual function of the “z” and “I” keys enable a user to utilize a two-key combination that commonly corresponds to the shift function while enabling the shift key to be removed from the format of the keyboard 104.

Similarly, other keys can have dual functionality based upon detection of multiple touch inputs. For example, the “a” key can insert an “a” when the touch input indicates a key strike of the “a” key (e.g., selection of the key). However, if the touch information indicates a press and hold of the “a” key and a touch input that is identified a strike of the “y” key, a “[” character can be inserted. In other words, when another key is struck during the lifetime of the depression of the “a” key, the gesture can indicate a shift function to secondary symbols that appear on keys of a conventional keyboard that have been removed from the keyboard described, e.g., “[”, “]”, and “\”. Though various implementations have been described in which the shift function can be indicated by a key having dual functionality, it is contemplated that other keyboard functions can be indicated by a key having dual functionality.

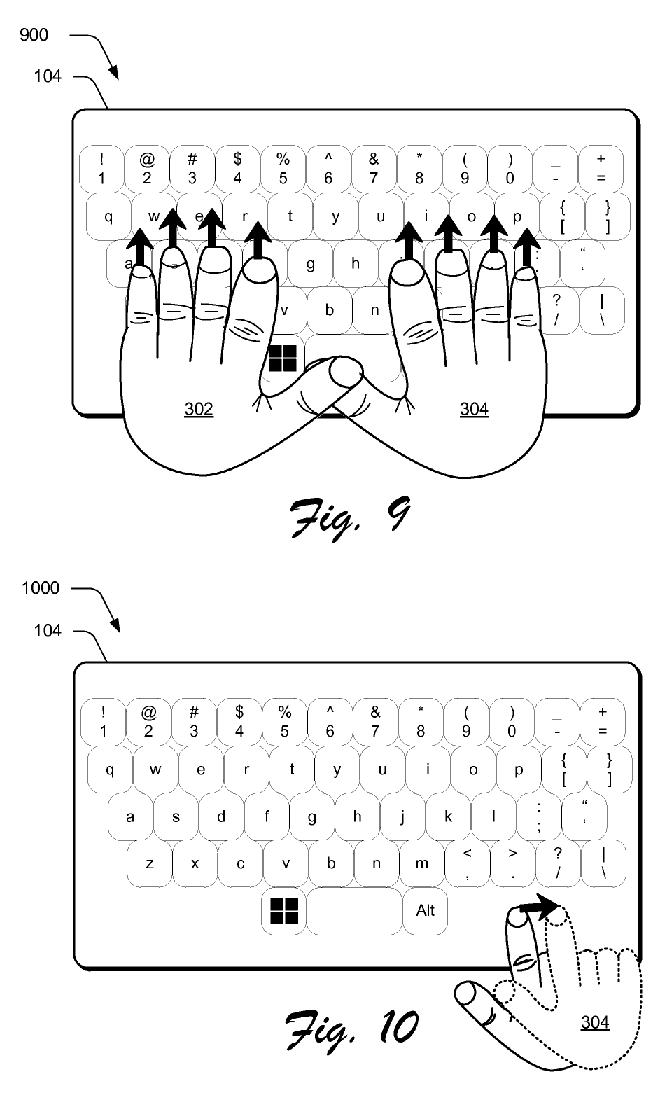

In FIG. 7, the example implementation 700 is illustrated as including the right hand 304 of the user pressing the alt key while the left hand 302 swipes from left to right on another key of the keyboard 104. This gesture can be recognized as indicating the function conventionally associated with pressing the tab and alt keys in combination. In particular, recognition of this gesture can enable a user to navigate through, e.g., switch between, one or more applications running on the computing device. Similarly, when the user swipes from right to left while pressing the alt key, navigation through the applications may be performed in a reverse order. Thus, the gesture may perform the function conventionally associated with pressing the shift, alt, and tab keys in combination.

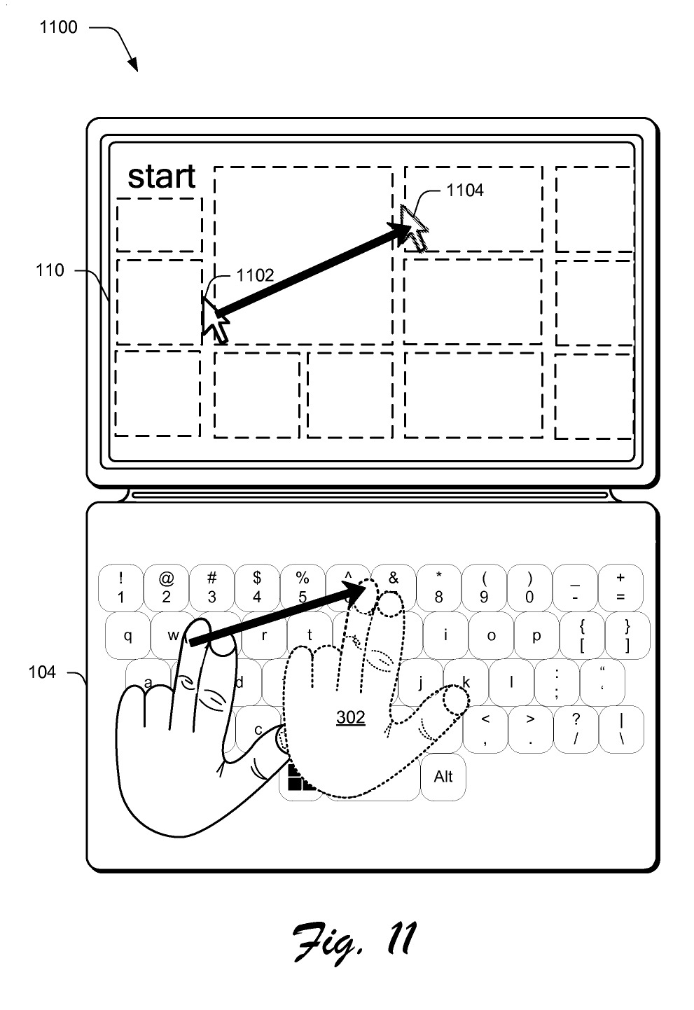

While some navigation functions may be indicated by gestures performed anywhere on the keyboard, in some implementations, a navigation key may be included in the keys of the keyboard 104. Consider, for example, the example implementation 800 illustrated in FIG. 8. Here, the key to the left of the spacebar on the keyboard 104 is a navigation key. The navigation key can be located elsewhere in the arrangement of keys, depending on the particular implementation. The user's left hand 302 is illustrated as swiping down on the navigation key. This gesture can be recognized as indicative of a page down function. Similarly, if the user swipes up on the navigation key, the gesture can be recognized as indicative of a page up function. As with the gestures indicative of the backspace and delete functions described above, the amount of movement may be indicated by the size, speed, and/or pressure of the touch input.

The navigation key can, in various implementations, engage application-specific keyboard functions. For example, a touch input identified as dragging left on the navigation key while a web browser application is active can cause the web browser to return to the previous page. Likewise, a touch input identified as dragging left on the navigation key while a word processing application is active can cause the word processor to scroll to the left of the document.

Turning now to FIG. 9, an example gesture utilizing multiple fingers is shown. Here, a gesture is shown in which four fingers from each of the user's left hand 302 and right hand 304 swipe up on the keys of the keyboard 104. Such a gesture can be indicative of a caps lock function. In some implementations, three fingers from each hand are used to perform the gesture to indicate the caps lock function. The caps lock function may be disengaged when the user performs the same gesture a second time, when the user swipes the fingers in a downward direction on the keys, and so on. Other multi-finger gestures may be used to indicate various keyboard functions. In various implementations, such gestures may be utilized when they do not conflict with other multi-touch gestures recognized by the computing device, e.g., such as for particular applications executed by the computing device 102 during receipt of the gesture, and so on.

Although gestures utilized by the techniques herein do not conflict with other gestures recognized by the computing device, in some implementations, the ability to toggle between modes of operation can enhance device functionality. For example, a user may toggle between a typing mode and a mousing mode. The mousing mode may be used to enable mousing gestures to be performed on the keys of the keyboard. Thus, a gesture performed on the keys of the keyboard can be recognized as a gesture indicative of a mousing function. Mousing functions can include, for example, functions configured to move of a cursor or pointer on a display, scroll, zoom, pan, cause a menu to be displayed on a user interface, indicate a selection on a user interface (e.g., single or double clicking), or the like. Responsive to recognizing such a gesture, an input corresponding to the mousing function can be generated by the computing device. In typing mode, the gestures performed on the keys are indicative of keyboard functions.

A gesture may be performed on the keys of the keyboard to toggle between modes. For example, a user may quickly swipe a finger back and forth on the keyboard to mimic shaking a mouse. This gesture can cause the computing device to switch into the mousing mode. Accordingly, any gestures performed may be associated with mousing functions rather than keyboard functions while in this mode. To return to typing mode, the user may press the “s”, “d”, and “f” keys in rapid succession, as though the user is drumming his or her fingers. Other gestures may be utilized to toggle between modes depending on the particular implementation.

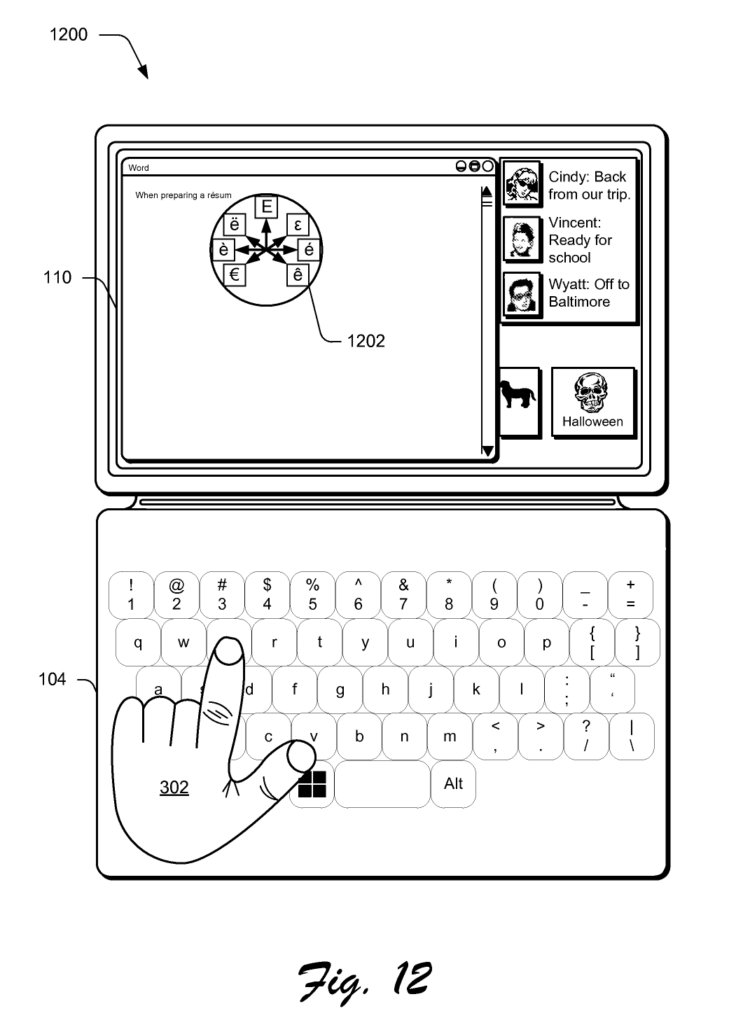

Alternately or additionally, a mode may be selected according to a starting location of a touch input. FIG. 10 illustrates an example implementation 1000 in which a finger of the user's right hand 304 swipes from left to right in beginning in a non-key region of the keyboard 104. This gesture can be recognized as a mousing gesture (e.g., a gesture indicative of a mousing function) because it begins in a non-key region of the keyboard 104. Thus, the user may continue the touch input over the keys, and the touch input will continue to be recognized as a mousing gesture for the remainder of the lifetime of the touch. Accordingly, if the user begins a touch in a non-key area, the computing device 102 may recognize the touch input as being a mousing gesture rather than a gesture indicative of a keyboard function.

In some implementations, a toggle button may also be included in the keys of the keyboard to toggle between various modes. For example, a gesture performed on the toggle button may indicate a switch to a symbol or function key mode, emoticon mode, a charm button or media control mode, or a number pad mode. Thus, a user may drag up on the toggle button to enter symbol or function key mode. Accordingly, keys pressed or gestures performed while in this mode may be indicative of symbols or function keys (F1, F2, etc.) Similarly, a user may drag left on the toggle button to enter number pad mode. Accordingly, keys of the keyboard may be recognized as indicating numbers rather than the letters or symbols that they are conventionally associated with. As another example, a user may drag right to enter a charms mode or media control mode. Thus, key presses or gestures may indicate functions that are associated with a charms bar or media control bar. In various implementations, a user may tap the toggle button to return to typing mode. Additional gestures may be recognized to enable the user to select a mousing mode.

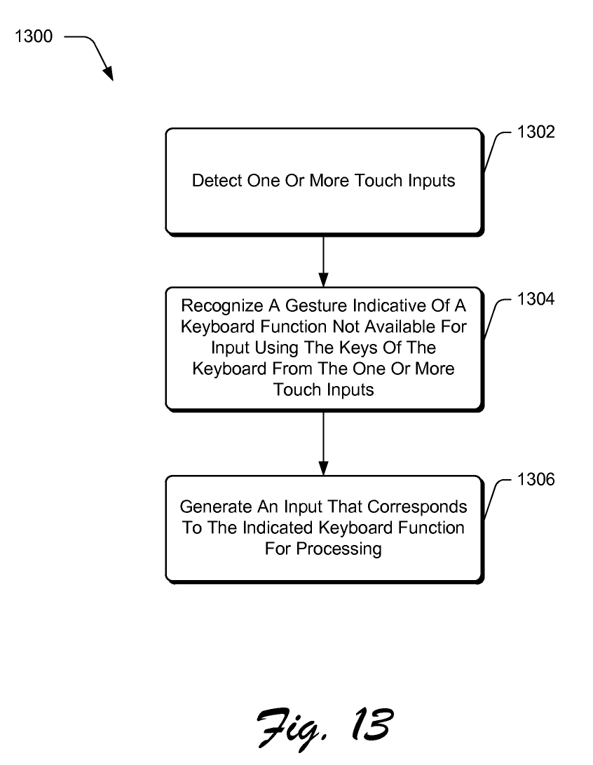

In various implementations, the computing device may recognize gestures indicative of mousing functions when the computing device has not been toggled into mousing mode. Thus, the computing device is configured to differentiate between gestures indicative of mousing functions and gestures indicative of keyboard functions. In order to ensure that gestures do not conflict, in some implementations, gestures indicative of mousing functions can be recognized from touch inputs from two fingers while single finger gestures and other multi-touch gestures can be indicative of other functions. In at least some implementations, the gesture is performed over at least one key that is also selectable to initiate a keyboard function via a key press. In the implementation 1100 in FIG. 11, an example gesture indicative of a mousing function is shown. Here, a gesture is shown in which two fingers from the user's left hand 302 swipe up and to the right on the keys of the keyboard 104. Such a gesture can be indicative of a function that operates to move the cursor displayed on display 110 from a position 1102 to a position 1104. The cursor movement function may be disengaged upon the end of the lifetime of the touch. Other gestures may be used to indicate various mousing functions. For example, a user may tap one finger while another finger remains in contact with the keyboard to indicate a mouse click. In various implementations, such gestures may be utilized when they do not conflict with other gestures recognized by the computing device, e.g., such as for particular applications executed by the computing device 102 during receipt of the gesture, and so on.

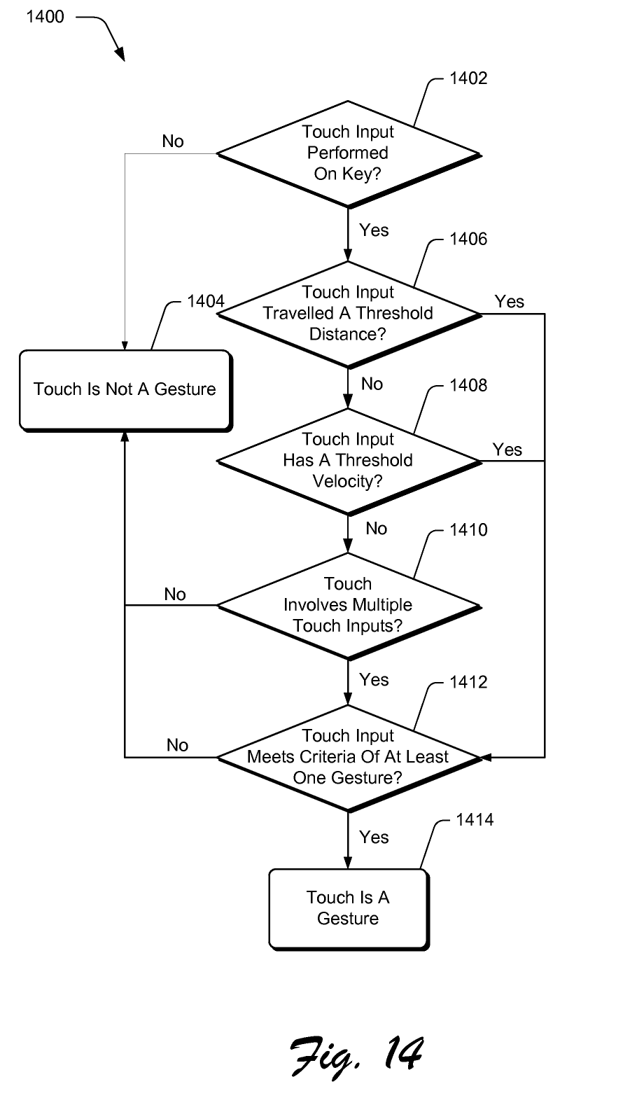

Although in FIGS. 1-11 a user performs a gesture that directly indicates a keyboard or mousing function, the techniques described may also be employed in implementations in which a radial menu is presented to a user responsive to a gesture. The radial menu can include one or more gestures and associated keyboard or mousing functions for selection by the user. The options for selection may vary depending on at least one key the gesture that caused the radial menu to be presented is performed on. FIG. 12 illustrates one such implementation.

In the example implementation 1200 of FIG. 12, a user's left hand 302 is illustrated as providing a touch input to a key of the keyboard 104. The radial menu 1202 shown on the display device 110 illustrates a number of options that are available for selection by the user. For example, the radial menu 1202 can provide a menu of various gestures that can be recognized from a touch input and a keyboard function that corresponds to each of the gestures. Thus, the user can be made aware of the keyboard functions available for input. This can enable a gesture to correspond to a different keyboard function in different applications or when performed on different keys while reducing potential user confusion. As shown in FIG. 12, the radial menu 1202 can enable, for example, a menu to be presented to a user based on a particular key, although the radial menu 1202 that is presented may be presented independent of the location of the touch input.

Example Procedures

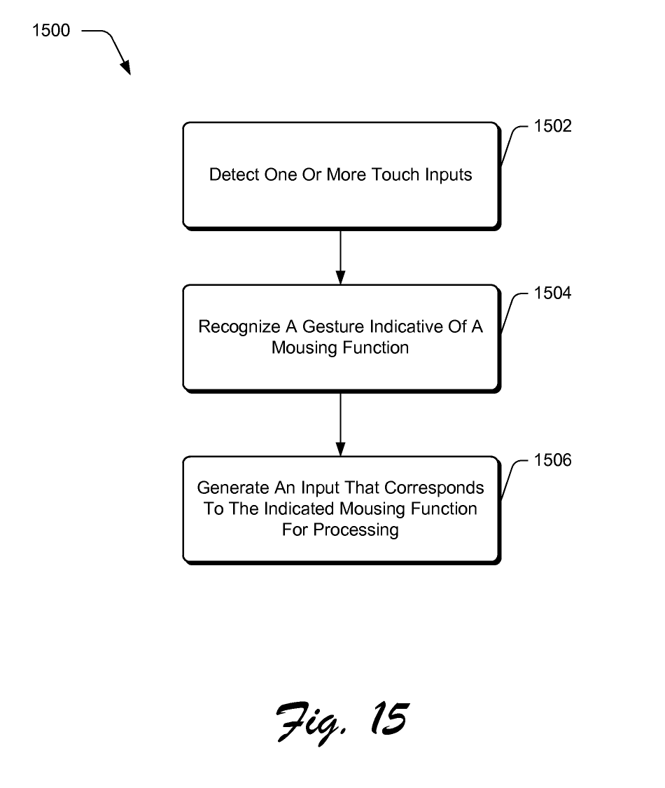

Turning now to FIG. 13, an example procedure 1300 for implementing the techniques described in accordance with one or more embodiments is illustrated. Procedure 1300 can be carried out by an input/output module, such as input/output module 108 of FIG. 1. The procedure can be implemented in software, firmware, hardware, or combinations thereof. Procedure 1300 is shown as a set of blocks and is not limited to the order shown for performing the operations of the various blocks. Procedure 1300 is an example procedure for implementing the techniques described herein; additional discussions of implementing the techniques described herein are included herein with reference to different figures.

Assume, as described above, that a user touches a key of a keyboard 104. The touch sensors associated with the key detect one or more touch inputs (block 1302). The touch sensors, in some implementations, may also provide information regarding a location of the touch input, a duration of the touch input, a distance travelled by the touch input, a velocity of the touch input, and the like.

The input/output module 108 then recognizes a gesture indicative of a keyboard function that is not available for input using the keys of the keyboard 104 from the one or more touch inputs (block 1304). For example, the input/output module 108 can recognize a swipe from left to right from the touch input. Then, based on the gesture, the input/output module 108 generates an input corresponding to the indicated keyboard function for processing (block 1306). Thus, continuing the previous example, the input/output module 108 can generate an input corresponding to a tab function for processing. Accordingly, the computing device 102 can process the tab function. For example, if a word processing application is active when the user performed the gesture, the cursor can be advanced to the next tab stop.

The input generated by the input/output module 108 depends on the gesture that is recognized from touch inputs to the keys of the keyboard 104. The input/output module 108 can recognize a gesture according to various procedures. FIG. 14 illustrates one procedure for recognizing a gesture.

FIG. 14 illustrates an example procedure 1400 for implementing the techniques described in accordance with one or more embodiments. Procedure 1400 can be carried out by an input/output module, such as input/output module 108 of FIG. 1. The procedure can be implemented in software, firmware, hardware, or combinations thereof. As above, procedure 1400 is shown as a set of blocks and is not limited to the order shown for performing the operations of the various blocks.

In procedure 1400, the input/output module 108 determines whether a touch input was performed on a key (block 1402). The touch input can be, for example, the touch input detected by the touch sensors at block 1302 in FIG. 13. The input/output module 108 may determine whether the touch input was performed on a key based on a comparison of location information associated with the touch input with location information for the keys of the keyboard 104. For example, the input/output module 108 can compare the location of a touch sensor that detected the touch input with known locations of the keys of the keyboard 104.

If the touch input is determined to be performed somewhere other than on the keys of the keyboard, the touch input is not determined to be a gesture and is filtered out by procedure 1400 (block 1404), although other implementations are also contemplated in which the touch input may be detected anywhere on the keyboard 104, using touch functionality of a display device 110, and so on. The touch input may be further processed according to other techniques. For example, the touch input may be processed to determine if the touch input is an input that corresponds to a command in a mousing mode.

If, however, the input/output module 108 determines that the touch input was performed on the keys of the keyboard 104, a check is made as to whether the touch input travelled at least a threshold distance (block 1406). This threshold distance can be a fixed distance (e.g., 0.25 inches) or a relative distance (e.g., 50% of the width of a key). The travelling of a touch refers to the distance moved by the user's finger while being moved along some path during the lifetime of the touch.

If the touch input did not travel at least a threshold distance, then a check is made as to whether the touch input has a threshold velocity (block 1408). The velocity of a touch refers to the distance moved by the user's finger while being moved along some path during the lifetime of the touch divided by the time duration of the lifetime of the touch. For example, the velocity may be 4 inches/second, although other velocities are contemplated.

If the touch input does not have a threshold velocity, then the input/output module 108 determines whether the touch involves multiple touch inputs (block 1410). For example, the input/output module 108 can determine if multiple touch inputs have been detected.

If the touch input travelled at least a threshold distance, had a threshold velocity, or involves multiple touch inputs, a check is made as to whether the touch input meets criteria of at least one gesture (block 1412). For example, characteristics of the touch input are compared to the characteristics of one or more gestures that indicate keyboard functions. If the characteristics of the touch input conform to the characteristics of a gesture, that gesture is recognized from the touch input. Thus, if the touch input meets the criteria of at least one gesture, the input/output module 108 determines that the touch is a gesture (block 1414). If the touch input does not conform to the characteristics of a gesture, the input/output module 108 determines that the touch is not a gesture (block 1404).

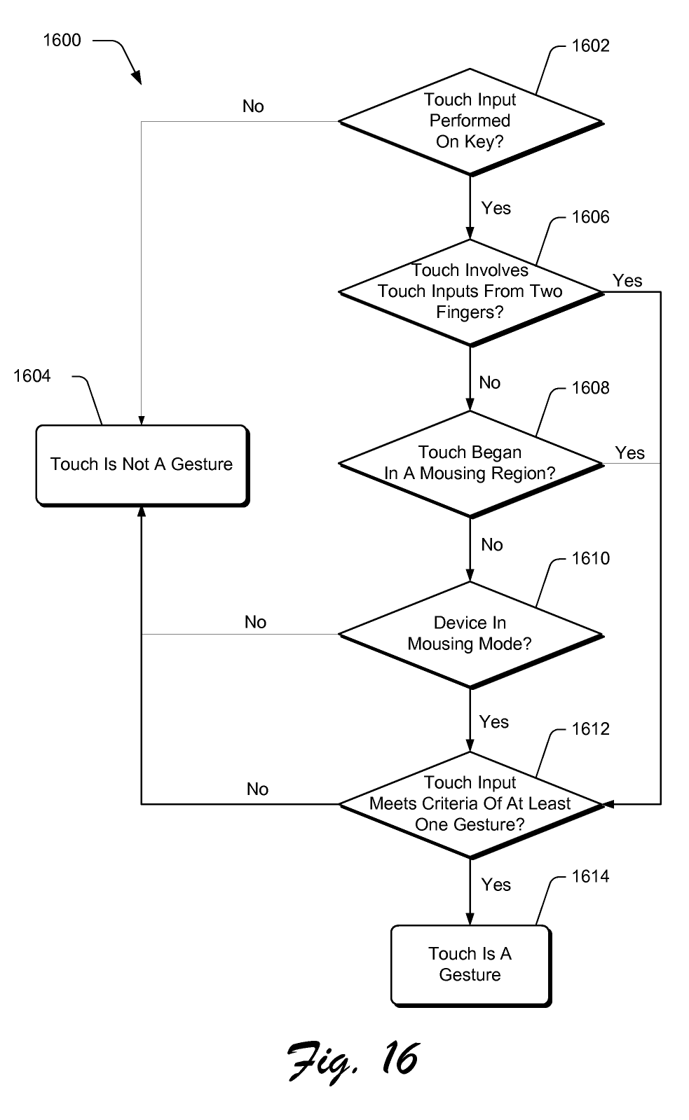

Turning now to FIG. 15, in implementations in which a gesture is indicative of a mousing function, a procedure 1500 may be implemented to generate an input corresponding to the indicated mousing function for processing. Procedure 1500 can be carried out by an input/output module, such as input/output module 108 of FIG. 1. The procedure can be implemented in software, firmware, hardware, or combinations thereof. Procedure 1500 is shown as a set of blocks and is not limited to the order shown for performing the operations of the various blocks. Procedure 1500 is an example procedure for implementing the techniques described herein; additional discussions of implementing the techniques described herein are included herein with reference to different figures.

Assume that a user touches a key of a keyboard 104 with two fingers, such as is illustrated in FIG. 11. The touch sensors associated with the key detect one or more touch inputs (block 1502). The touch sensors, in some implementations, may also provide information regarding a location of the touch input, a duration of the touch input, a distance travelled by the touch input, a velocity of the touch input, and the like.

The input/output module 108 then recognizes a gesture indicative of a mousing function from the one or more touch inputs (block 1504). For example, the input/output module 108 can recognize a two-finger swipe up and to the right from the touch input. Then, based on the gesture, the input/output module 108 generates an input corresponding to the indicated mousing function for processing (block 1506). Thus, continuing the previous example, the input/output module 108 can generate an input that causes a cursor to be moved on the display device 110 for processing.

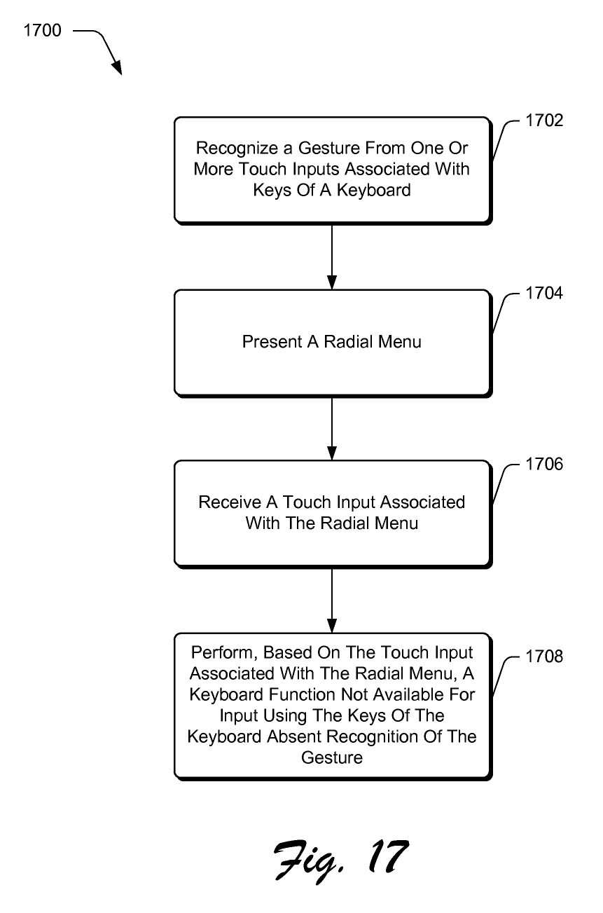

As above, the input generated by the input/output module 108 depends on the gesture that is recognized from touch inputs to the keys of the keyboard 104. The input/output module 108 can recognize a gesture that is indicative of a mousing function according to various procedures. FIG. 16 illustrates one such procedure.

FIG. 16 illustrates an example procedure 1600 for implementing the techniques described in accordance with one or more embodiments. Procedure 1600 can be carried out by an input/output module, such as input/output module 108 of FIG. 1. The procedure can be implemented in software, firmware, hardware, or combinations thereof. As above, procedure 1600 is shown as a set of blocks and is not limited to the order shown for performing the operations of the various blocks.

In procedure 1600, the input/output module 108 determines whether a touch input was performed on a key (block 1602). The touch input can be, for example, the touch input detected by the touch sensors at block 1502 in FIG. 15. The input/output module 108 may determine whether the touch input was performed on a key based on a comparison of location information associated with the touch input with location information for the keys of the keyboard 104. For example, the input/output module 108 can compare the location of a touch sensor that detected the touch input with known locations of the keys of the keyboard 104. In some implementations, a touch input that is performed at least partially on a key is treated as a touch input that was performed on a key. Thus, if the touch input travels from a location not associated with a key of the keyboard to a location associated with a key of the keyboard, the input/output module 108 determines that the touch input was performed on a key.

If the touch input is determined to be performed somewhere other than on the keys of the keyboard, the touch input is not determined to be a gesture and is filtered out by procedure 1600 (block 1604), although other implementations are also contemplated in which the touch input may be detected anywhere on the keyboard 104, using touch functionality of a display device 110, and so on. The touch input may be further processed according to other techniques. For example, the touch input may be processed to determine if the touch input is an input that corresponds to a multi-finger gesture or a gesture indicative of a keyboard function.

If, however, the input/output module 108 determines that the touch input was performed on the keys of the keyboard 104, a check is made as to whether the touch input involves touch inputs from two fingers (block 1606). For example, the input/output module 108 can determine if the touch input is associated with a touch involving two fingers.

If the touch did not involve touch inputs from two fingers, then a check is made as to whether the touch began in a mousing region (block 1608). A mousing region can be a region of the keyboard that does not include keys. For example, the gesture in FIG. 10 is performed in a non-key region located below the keys of the keyboard that can be a mousing region.

If the touch did not begin in a mousing region, then the input/output module 108 determines whether the device is in mousing mode (block 1610). For example, the input/output module 108 can determine if a user has switched to mousing mode from typing mode.

If the touch involved touch inputs from two fingers, began in a mousing region, or occurred while the device was in mousing mode, a check is made as to whether the touch input meets criteria of at least one gesture (block 1612). For example, characteristics of the touch input are compared to the characteristics of one or more gestures that indicate mousing functions. If the characteristics of the touch input conform to the characteristics of a gesture, that gesture is recognized from the touch input. Thus, if the touch input meets the criteria of at least one gesture, the input/output module 108 determines that the touch is a gesture (block 1614). If the touch input does not conform to the characteristics of a gesture, the input/output module 108 determines that the touch is not a gesture (block 1604).

As described above, in some implementations, a radial menu can be displayed to a user responsive to recognition of a gesture. FIG. 17 illustrates an example procedure 1700 for implementing a radial menu. Procedure 1700 can be carried out by an input/output module, such as input/output module 108 of FIG. 1. The procedure can be implemented in software, firmware, hardware, or combinations thereof. As above, procedure 1700 is shown as a set of blocks and is not limited to the order shown for performing the operations of the various blocks.

Procedure 1700 begins when input/output module 108 recognizes a gesture from one or more touch inputs associated with keys of a keyboard (block 1702). The gesture may be recognized according to procedure 1400, for example.

Responsive to recognition of a gesture, a radial menu is presented (block 1704). For example, the input/output module 108 can cause radial menu 1202 to be displayed on a display device 110. The radial menu 1202 can display a number of options in the form of gestures. A keyboard function is associated with each gesture.

Next, the input/output module 108 receives a touch input associated with the radial menu (block 1706). For example, the input/output module 108 may receive touch information from a touch sensor responsive to a user performing a gesture included on the radial menu 1202. Finally, the input/output module 108 causes the computing device 102 to perform a keyboard function that is not available for input using the keys of the keyboard absent recognition of the gesture (block 1708). The keyboard function that is performed is based on the touch input associated with the radial menu 1202. For example, assume the radial menu 1202 indicates that a swipe to the right will cause an “é” to be inserted, as shown in FIG. 12. When the input/output module 108 recognises a swipe to the right from the touch input, the input/output module 108 will cause the “é” to be inserted.

Example System and Device

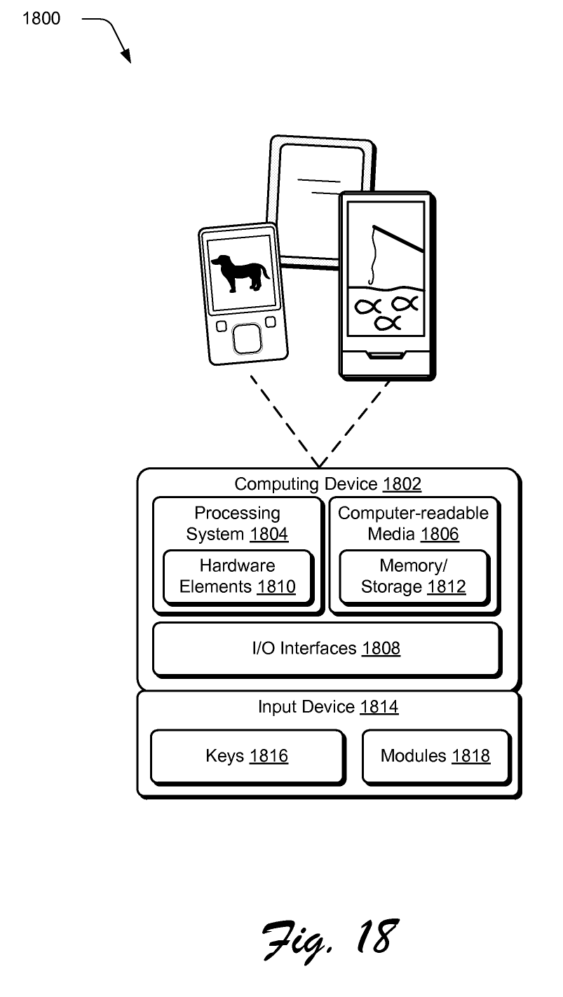

FIG. 18 illustrates an example system generally at 1800 that includes an example computing device 1802 that is representative of one or more computing systems and/or devices that may implement the various techniques described herein. The computing device 1802 may, for example, be configured to assume a mobile configuration through use of a housing formed and size to be grasped and carried by one or more hands of a user, illustrated examples of which include a mobile phone, mobile game and music device, and tablet computer although other examples are also contemplated.

The example computing device 1802 as illustrated includes a processing system 1804, one or more computer-readable media 1806, and one or more I/O interfaces 1808 that are communicatively coupled, one to another. Although not shown, the computing device 1802 may further include a system bus or other data and command transfer system that couples the various components, one to another. A system bus can include any one or combination of different bus structures, such as a memory bus or memory controller, a peripheral bus, a universal serial bus, and/or a processor or local bus that utilizes any of a variety of bus architectures. A variety of other examples are also contemplated, such as control and data lines.

The processing system 1804 is representative of functionality to perform one or more operations using hardware. Accordingly, the processing system 1804 is illustrated as including hardware elements 1810 that may be configured as processors, functional blocks, and so forth. This may include implementation in hardware as an application specific integrated circuit or other logic device formed using one or more semiconductors. The hardware elements 1810 are not limited by the materials from which they are formed or the processing mechanisms employed therein. For example, processors may be comprised of semiconductor(s) and/or transistors (e.g., electronic integrated circuits (ICs)). In such a context, processor-executable instructions may be electronically-executable instructions.

The computer-readable storage media 1806 is illustrated as including memory/storage 1812. The memory/storage 1812 represents memory/storage capacity associated with one or more computer-readable media. The memory/storage component 1812 may include volatile media (such as random access memory (RAM)) and/or nonvolatile media (such as read only memory (ROM), Flash memory, optical disks, magnetic disks, and so forth). The memory/storage component 1812 may include fixed media (e.g., RAM, ROM, a fixed hard drive, and so on) as well as removable media (e.g., Flash memory, a removable hard drive, an optical disc, and so forth). The computer-readable media 1806 may be configured in a variety of other ways as further described below.

Input/output (I/O) interface(s) 1808 are representative of functionality to allow a user to enter commands and information to computing device 1802, and also allow information to be presented to the user and/or other components or devices using various input/output devices. Examples of input devices include a keyboard, a cursor control device (e.g., a mouse), a microphone, a scanner, touch functionality (e.g., capacitive, optical, or other sensors that are configured to detect physical touch), a camera (e.g., which may employ visible or non-visible wavelengths such as infrared frequencies to recognize movement as gestures that do not involve touch), and so forth. Examples of output devices include a display device (e.g., a monitor or projector), speakers, a printer, a network card, tactile-response device, and so forth. Thus, the computing device 1802 may be configured in a variety of ways to support user interaction.

The computing device 1802 is further illustrated as being communicatively and physically coupled to an input device 1814 that is physically and communicatively removable from the computing device 1802. In this way, a variety of different input devices may be coupled to the computing device 1802 having a wide variety of configurations to support a wide variety of functionality. In this example, the input device 1814 includes one or more keys 1816, which may be configured as pressure sensitive keys, keys on a touchpad or touchscreen, mechanically switched keys, and so forth.

The input device 1814 is further illustrated as including one or more modules 1818 that may be configured to support a variety of functionality. The one or more modules 1818, for instance, may be configured to process analog and/or digital signals received from the keys 1816 to determine whether a keystroke was intended, determine whether an input is indicative of resting pressure, support authentication of the input device 1814 for operation with the computing device 1802, recognize a gesture from the touch input, and so on.

Although illustrated as separate from the computing device 1802, the input device 1814 can alternatively be included as part of the computing device 1802 as discussed above. In such situations, the keys 1816 and the modules 1818 are included as part of the computing device 1802. Additionally, in such situations the keys 1816 may be keys of a virtual keyboard and/or keys of a non-virtual keyboard (e.g., a pressure sensitive input device).

Various techniques may be described herein in the general context of software, hardware elements, or program modules. Generally, such modules include routines, programs, objects, elements, components, data structures, and so forth that perform particular tasks or implement particular abstract data types. The terms “module,” “functionality,” and “component” as used herein generally represent software, firmware, hardware, or a combination thereof. The features of the techniques described herein are platform-independent, meaning that the techniques may be implemented on a variety of commercial computing platforms having a variety of processors.

An implementation of the described modules and techniques may be stored on or transmitted across some form of computer-readable media. The computer-readable media may include a variety of media that may be accessed by the computing device 1802. By way of example, and not limitation, computer-readable media may include “computer-readable storage media” and “computer-readable signal media.”

“Computer-readable storage media” may refer to media and/or devices that enable persistent storage of information in contrast to mere signal transmission, carrier waves, or signals per se. Thus, computer-readable storage media refers to non-signal bearing media. The computer-readable storage media includes hardware such as volatile and non-volatile, removable and non-removable media and/or storage devices implemented in a method or technology suitable for storage of information such as computer readable instructions, data structures, program modules, logic elements/circuits, or other data. Examples of computer-readable storage media may include, but are not limited to, RAM, ROM, EEPROM, flash memory or other memory technology, CD-ROM, digital versatile disks (DVD) or other optical storage, hard disks, magnetic cassettes, magnetic tape, magnetic disk storage or other magnetic storage devices, or other storage device, tangible media, or article of manufacture suitable to store the desired information and which may be accessed by a computer.

“Computer-readable signal media” may refer to a signal-bearing medium that is configured to transmit instructions to the hardware of the computing device 1802, such as via a network. Signal media typically may embody computer readable instructions, data structures, program modules, or other data in a modulated data signal, such as carrier waves, data signals, or other transport mechanism. Signal media also include any information delivery media. The term “modulated data signal” means a signal that has one or more of its characteristics set or changed in such a manner as to encode information in the signal. By way of example, and not limitation, communication media include wired media such as a wired network or direct-wired connection, and wireless media such as acoustic, RF, infrared, and other wireless media.

As previously described, hardware elements 1810 and computer-readable media 1806 are representative of modules, programmable device logic and/or fixed device logic implemented in a hardware form that may be employed in some embodiments to implement at least some aspects of the techniques described herein, such as to perform one or more instructions. Hardware may include components of an integrated circuit or on-chip system, an application-specific integrated circuit (ASIC), a field-programmable gate array (FPGA), a complex programmable logic device (CPLD), and other implementations in silicon or other hardware. In this context, hardware may operate as a processing device that performs program tasks defined by instructions and/or logic embodied by the hardware as well as a hardware utilized to store instructions for execution, e.g., the computer-readable storage media described previously.

Combinations of the foregoing may also be employed to implement various techniques described herein. Accordingly, software, hardware, or executable modules may be implemented as one or more instructions and/or logic embodied on some form of computer-readable storage media and/or by one or more hardware elements 1810. The computing device 1802 may be configured to implement particular instructions and/or functions corresponding to the software and/or hardware modules. Accordingly, implementation of a module that is executable by the computing device 1802 as software may be achieved at least partially in hardware, e.g., through use of computer-readable storage media and/or hardware elements 1810 of the processing system 1804. The instructions and/or functions may be executable/operable by one or more articles of manufacture (for example, one or more computing devices 1802 and/or processing systems 1804) to implement techniques, modules, and examples described herein.

### CONCLUSION

Although the example implementations have been described in language specific to structural features and/or methodological acts, it is to be understood that the implementations defined in the appended claims is not necessarily limited to the specific features or acts described. Rather, the specific features and acts are disclosed as example forms of implementing the claimed features.

What is claimed is:

1. A method comprising:
detecting one or more touch inputs using one or more touch sensors associated with one or more keys of a keyboard;
recognizing a gesture from the one or more touch inputs by a computing device, the gesture indicative of a keyboard function; and
responsive to the gesture, generating, by the computing device, an input that corresponds to the indicated keyboard function for processing, the indicated keyboard function not available for input using the keys of the keyboard absent the recognition of the gesture.

2. The method of claim 1, wherein the keyboard function is associated with a key of a keyboard format with which the keyboard complies substantially but is not included as part of the keyboard.

3. The method of claim 2, wherein the keyboard function is conventionally associated with a key of the keyboard format that is selectable in combination with another key of the keyboard format to provide an input.

4. The method of claim 3, wherein the keyboard function is a shift, control, alt, or caps lock keyboard function.

5. The method of claim 1, wherein the keyboard function is an editing function.

6. The method of claim 1, wherein the one or more touch sensors are configured as pressure-sensitive touch sensors.

7. The method of claim 1, wherein the one or more touch sensors are configured as capacitive touch sensors.

8. The method of claim 1, further comprising responsive to the recognizing of the gesture:
presenting a radial menu;
receiving a touch input associated with the radial menu; and
performing, based on the touch input associated with the radial menu, the keyboard function.

9. The method of claim 8, wherein the keyboard function is associated with a key of a keyboard format with which the keyboard complies substantially but is not included as part of the keyboard.

10. A system comprising a computing device and a pressure-sensitive keyboard, the computing device configured to identify a keyboard function from a gesture, the gesture recognized from touch inputs detected using a plurality of keys of the pressure-sensitive keyboard.

11. The system of claim 10, wherein the keyboard function comprises an editing function.

12. The system of claim 11, wherein the editing function is a shift, tab, backspace, or enter function.

13. The system of claim 10, wherein the keyboard function comprises a navigation function.

14. The system of claim 10, wherein the keyboard function is a shift, caps lock, tab, backspace, enter, escape, or control function.

15. The system of claim 10, wherein the pressure-sensitive keyboard is configured in a QWERTY keyboard format and does not include at least one key that is conventionally located at an edge of the keyboard format.

16. A method comprising:
recognizing a gesture from one or more touch inputs detected by one or more touch sensors associated with a plurality of keys of a keyboard, the gesture indicative of a mousing function; and
responsive to the gesture, generating, by a computing device, an input that corresponds to the indicated mousing function for processing.

17. The method of claim 16, wherein the one or more touch sensors are configured as pressure-sensitive touch sensors.

18. The method of claim 16, wherein the mousing function is a function configured to click, scroll, pan, zoom, move a cursor or pointer displayed on a display device, or cause a menu to be displayed on a user interface.

19. The method of claim 16, wherein the recognizing is configured to differentiate between gestures indicative of a mousing function and gestures indicative of a keyboard function.

20. The method of claim 16, wherein the one or more touch sensors are associated with keys that are selectable to also initiate a keyboard function via a key press.
